(19) United States
(12) Patent Application Publication
(10) Pub. No.: US 2011/0038426 A1
(43) Pub. Date: Feb. 17, 2011

(54) TRANSMISSION SYSTEM AND TRANSMISSION METHOD

(75) Inventors: Hideki KOBA, Ome (JP); Takashi MUTO, Hamura (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/834,777

(22) Filed: Jul. 12, 2010

(30) Foreign Application Priority Data
Aug. 17, 2009 (JP) 2009-188188

(51) Int. Cl. H04B 3/00

(52) U.S. Cl. 375/257

(57) ABSTRACT

In order to optimize with high accuracy parameters that a fast I/F has, optimization by training is required. Regarding these parameters, their optimum values vary to an operating frequency band and a power supply voltage of the I/F. In order to lower the operating frequency band and lower the power supply voltage for reduction of power consumption, re-training that requires a time becomes needed. By obtaining in advance optimum combinations of the operating frequency band, the power supply voltage, and various parameters of the I/F for various parameters of the I/F and then by making a table with them, it is possible to optimize the parameters in a short time by referring to the table in optimizing the power supply voltage. By the optimization of the parameters in a short time being enabled, it is also possible to perform dynamic optimization during an operation of the device.

### CLAIM OF PRIORITY

The present application claims priority from Japanese patent application JP 2008-188188 filed on Aug. 17, 2009, the content of which is hereby incorporated by reference into this application.

### FIELD OF THE INVENTION

The present invention relates to a transmission device of data, a transmission system, and a transmission method.

### BACKGROUND OF THE INVENTION

As semiconductor integrated circuits become enhanced in performance and operating frequencies become higher, their power consumptions tend to increase year by year. Especially, with increase in data transmission speed of recent years, an electric power ratio of interface (I/F) circuits, such as an I/O and a SERDES circuit, in the whole of the large-scale integrated circuit (LSI) is increasing, and consequently, there are demands for power consumption reduction of the I/F circuits. The power consumption by charge/discharge that mainly governs the power consumption at the time of an operation of the semiconductor integrated circuit is almost proportional to the square of a power supply voltage. Therefore, it can be said that lowering the power supply voltage is the most effective means for the power consumption reduction. Moreover, in the I/O circuit, the SERDES circuit, etc. that operate fast, a CML (Current Mode Logic), a receiving-end resistance for impedance matching, etc. are indispensable, and also for these circuits in which currents are regularly flowed, lowering the power supply voltage is effective means for reduction of the power consumption.

On the other hand, in a fast I/F in the order of a few Gbps, an increase in transmission loss of a transmission line and an influence of inter-symbol interference (ISI) become noticeable, which become obstacles against correct data transmission. In the fast I/F, in order to solve this problem, a preemphasis technology, an equalizer technology, etc. are used to cope with the problem. The preemphasis technology is a technology of adjusting amplitudes of level 0 and level 1 of an output waveform considering in advance an influence of the ISI, and enables a waveform after passing through the transmission line to be brought near to a waveform with the influence of the ISI canceled out. Parameters of the preemphasis include an emphasis strength that fixes a strength of the emphasis and a TAP setting that fixes an emphasis pattern. If optimum settings are not made, it will increase the influence of the ISI. Therefore, it is necessary to make high-accuracy settings that are fitted to the transmission line. The equalizer technology is a technology that amplifies high frequency components of an input waveform with an amplifier on the receiving side considering reduction of the waveform amplitude by the transmission loss after passing through the transmission line. As a parameter of the equalizer technology, there is an equalizer strength (adjustment of an amplification factor). Since too much amplification results in reduction of an S/N ratio (signal to noise ratio) of a received signal but insufficient amplification cannot compensate decrease of the waveform by the transmission loss, a high-accuracy setting that is fitted to the transmission line is required.

The parameters of the emphasis control and the equalizer strength need to be adjusted with high accuracy also to a difference in attenuation characteristics caused by a wire-length difference within an LSI, a length difference of the transmission line for connecting LSIs, a difference by manufacture variation, etc., and an optimum parameter setting for each actual transmission line is required. For this reason, it is necessary to perform the emphasis control whereby the emphasis strength and the TAP are set up and to fix setting values of parameters, such as the equalizer strength by the training of setting optimum parameters while performing transmission characteristic evaluation on a finished system.

The optimization of the power supply voltage to the I/F circuit is carried out in various forms, and U.S. Pat. No. 6,278,305 shows an I/F that monitors Tr/Tf and optimizes the power supply voltage. Moreover, U.S. Pat. No. 7,180,812 shows a circuit that optimizes the power supply voltage by having and switching the use of I/Fs of a plurality of power supply voltage specifications.

### SUMMARY OF THE INVENTION

In order to reduce power consumption, it is effective to optimize a power supply voltage of a fast I/F depending on an operating environment. For example, even when a certain fast. I/F macro operates in an operating frequency band of 1 GHz for Application A, i.e., when it operates at 10 GHz at the maximum, but when it operates in an operating frequency band of 1 GHz for Application B, i.e., when operating only at 1 GHz at the maximum, it is possible to reduce the power consumption by lowering the power supply voltage for Application B.

However, when actually lowering the power supply voltage for the fast I/F, there is a problem that it requires much time in order to optimize the parameters that the fast I/F has. The fast I/F has parameters of an emphasis strength, an equalizer strength, an offset, a sending-end resistance value, a current source voltage value, etc. and these need to be optimized with high accuracy. Since the optimum values of these parameters vary to a variation of the power supply voltage, when intending to lower the power supply voltage, optimization of every parameter must be done so that it may fit to the power supply voltage. For this reason, in order to realize the optimization of every parameter after lowering the power supply voltage, readjustment and re-training become necessary. Especially, the training of the emphasis strength, the equalizer strength, the offset, etc. need determination of transmission performance by BER (Bit Error Rate) evaluation or EYE pattern evaluation. For example, since it is necessary to perform the evaluation of signals of 10⁵ patterns for all combinations of the parameters, the training will require a huge time.

An outline of a typical aspect among several aspects of the present invention that is disclosed in this application will be briefly explained. The above-mentioned problem is solved by storing optimum power supply voltage and various parameters for the each operating environment of an I/F acting as a transmitter and an I/F acting as a receiver in the form of a table, referring to the table in response to a variation of the operating environment, and optimizing the power supply voltage and the various parameters. Thereby, optimization in a short time can be performed when the operating environment varies.

Effects that can be obtained by the typical aspects of the present invention among several aspects thereof disclosed by this application will be briefly explained as follows.

It is possible to realize power consumption reduction by lowering the power supply voltage of the I/F depending on the operating environment. Moreover, it is possible to, when having reduced the power supply voltage of the I/F depending on the operating environment, optimize each parameter in a short time. By enabling to optimize the parameters in a short time, it is also possible to perform dynamic optimization during an operation of a device. That is, it is possible to realize the power consumption reduction while keeping the various parameters of the I/F optimal.

### BRIEF DESCRIPTION OF THE DRAWINGS

FIG. 1 is a diagram showing a configuration of a system including a fast I/F;

FIG. 2 is an example of an I/F parameter optimization table;

FIG. 3 is a diagram showing a flowchart of a processing of optimizing the I/F parameters;

FIG. 4 is a diagram showing a configuration of a transmitting side I/F;

FIG. 5 is a diagram showing a configuration of a receiving side I/F;

FIG. 6 is a diagram showing a configuration of a training mode of the system including the I/F;

FIG. 7 is a diagram showing a concrete example of the training mode to the I/F having parameters; and

FIG. 8 is a diagram showing a flowchart of a processing of obtaining the I/F parameters by the training and making a table with them.

### DETAILED DESCRIPTION OF THE PREFERRED EMBODIMENTS

Hereafter, the present invention will be described in detail based on embodiments.

### First Embodiment

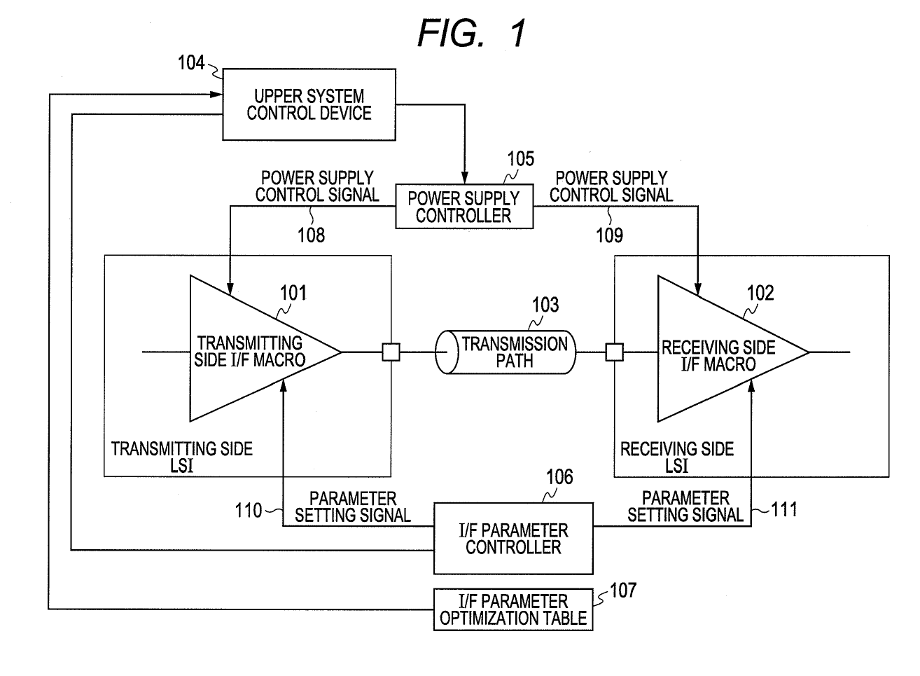

FIG. 1 is a diagram showing a configuration of a transmission system including a fast I/F. This embodiment shows the system for optimizing a power supply voltage and various parameters of a transmitter and a receiver according to an operating frequency band. The transmission system of this embodiment consists of a transmitting side I/F macro 101 working as the transmitter that is in the interior of a transmitting side LSI, a receiving side I/F macro 102 working as the receiver that is in the interior of a receiving side LSI, and a transmission line 103 for connecting the transmitting side I/F macro 101 and the receiving side I/F macro 102. The transmitting side I/F macro 101 has a plurality of operating frequency bands. The receiving side I/F macro 102 also has a plurality of operating frequency bands corresponding to those of the transmitting side I/F macro 101. Moreover, the transmission system of this embodiment has an upper system control device 104, a power supply controller 105, an I/F parameter controller 106, and an I/F parameter optimization table 107.

The power supply controller 105 is a circuit for controlling the power supply voltage supplied to the I/F on the system and, for example, is a control circuit equipped with a DC-DC converter. The I/F parameter controller 106 sets I/F parameters to the transmitting side I/F macro 101 and to the receiving side I/F macro 102, respectively. The I/F parameter optimization table 107 is stored, for example, in a storage device, such as RAM, flash memory, a register file, and a hard disk drive. The I/F parameter optimization table 107 contains the power supply voltage, an emphasis strength, and an equalizer strength of the transmitting side I/F macro 101 and the receiving side I/F macro 102 that are obtained in advance for the each operating frequency band of the transmission system.

In order to explain an operation of the transmission system of this embodiment, as an example, there will be explained an operation in the case of optimizing the power supply voltage and the various parameters of the I/Fs when the application handled by the whole system also including the transmitting side LSI and the receiving side LSI changes from Application A to Application B, and thereby the operating frequency changes from 5 GHz at the maximum to 0.5 GHz at the maximum, that is, when the operating frequency is lowered from 5 GHz to 0.5 GHz.

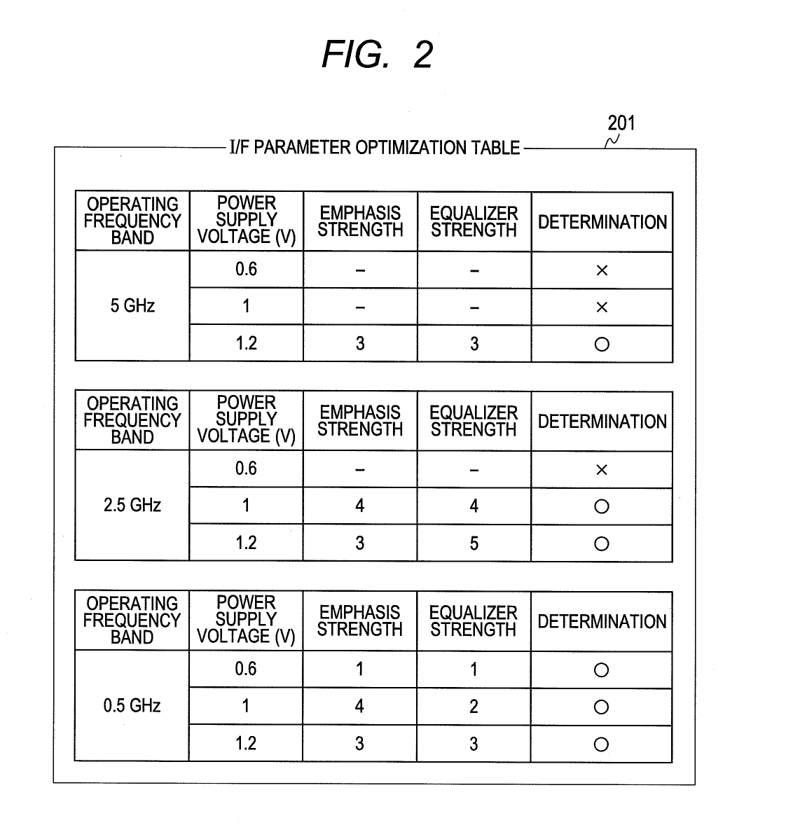

The upper system control device 104 monitors a working state of the whole system also including the transmitting side LSI and the receiving side LSI, and fixes the operating frequency band of the transmitting side I/F macro 101 and the receiving side I/F macro 102, i.e., the operating frequency band of the transmission system. In this example, the upper system control device 104 monitors and detects that Application A is switched to Application B, and decides that the operating frequency band of the transmitting side I/F macro 101 and the receiving side I/F macro 102 shall be lowered from 5 GHz to 0.5 GHz. Moreover, the upper system control device 104 acquires setting information of optimum power supply voltage value and various I/F parameters of the transmitting side I/F macro 101 and the receiving side I/F macro 102 from the I/F parameter optimization table 107 based on the operating frequency band that was fixed. For example, data shown in an I/F parameter optimization table 201 of FIG. 2 is stored in advance in the I/F parameter optimization table 107. If this table is searched using an “operating frequency band of 0.5 GHz” as a keyword, parameters of the “power supply voltage,” the “emphasis strength,” and the “equalizer strength” can be acquired. Since it aims at lowering power consumption, the upper system control device 104 selects conditions under which the power supply voltage is the lowest from among parameters acquirable from the I/F parameter optimization table 107. In this embodiment, parameters of a “power supply voltage of 0.6 (V)”, an “emphasis strength of 1”, and an “equalizer strength of 1” are acquired. Although this embodiment showed an example where the emphasis strength is tabulated as a setting parameter of the transmitting side I/F macro 101 and the equalizer strength is tabulated as a setting parameter of the receiving side I/F macro 102, it is also possible to tabulate an output amplitude control value, a sending-end resistance control value, etc. in advance other than the emphasis strength and the equalizer strength and to acquire them therefrom.

The upper system control device 104 outputs the setting parameter of the power supply voltage acquired from the I/F parameter optimization table 107 to the power supply controller 105, and outputs the parameters of each I/F to the I/F parameter controller 106. Based on the parameters acquired from the upper system control device 104, the power supply controller 105 transmits a power supply control signal 108 to the transmitting side I/F macro 101 and a power supply control signal 109 to the receiving side I/F macro 102, respectively, and sets the power supply voltage of the transmitting side I/F macro 101 and the receiving side I/F macro 102. Thereby, it is possible to optimize the power supply voltage of the transmitting side I/F macro 101 and the receiving side I/F macro 102, i.e., to reduce electric power. Incidentally, although the same power supply voltage value is set both at the transmitting side I/F macro 101 and at the receiving side I/F macro 102, there is a case where mutually different power supply voltage values are optimum values. In the case where the mutually different power supply voltage values are respective optimum values thereof, the respective optimum power supply voltage values are stored in the I/F parameter optimization table 107 and the respective optimum power supply voltages are set to the transmitting side I/F macro 101 and the receiving side I/F macro 102, respectively. Based on the parameters acquired from the upper system control device 104, the I/F parameter controller 106 transmits a parameter setting signal 110 to the transmitting side I/F macro 101 and a parameter setting signal 111 to the receiving side I/F macro 102, and sets the respective I/F parameters. In this embodiment, a power supply voltage of 0.6 V is set to the transmitting side I/F macro 101 and the receiving side I/F macro 102, an “emphasis strength of 1” is set to the transmitting side I/F macro 101, and an “equalizer strength of 1” is set to the receiving side I/F macro 102. Thereby, the power supply voltage currently optimized for reduced electric power is obtained instantly, and the I/F parameters currently optimized at the power supply voltage that is optimized for the reduced electric power are set in a short time between before and after varying the power supply voltage without performing readjustment and re-training. Therefore, it is possible to dynamically lower the power consumption of the transmission system when the application is changed and the operating frequency varies.

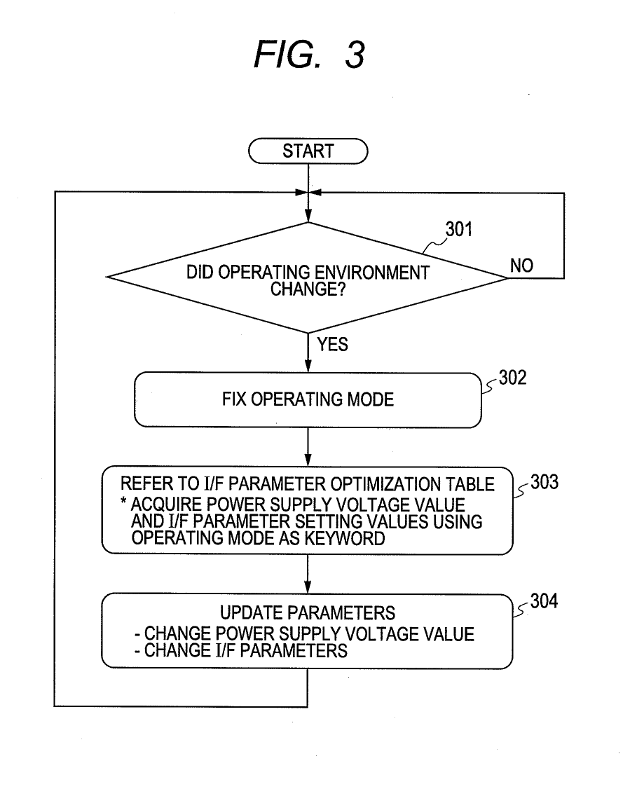

FIG. 3 shows a flowchart of a processing of optimizing the I/F parameters when an operating environment changed and switching of the operating frequency band is performed in the transmission, system of this embodiment. If the operating environment changes at Step 301, the process will proceed to Step 302. The case where the operating environment changed in the explanation of this embodiment is a case where the application that the system processes changed from Application A to Application B, as described above. A determination as to whether the operating environment changed is made by the upper system control device 104. Unless a change of the operating environment is detected, the process stands by at Step 301, and waits for a change of the operating environment. Therefore, if there is no change of the operating environment, transmission of data will be performed while the conditions being set to the I/F are maintained. If there is a change of the operating environment and the process proceeds to Step 302, the upper system control device 104 will fix the operating frequency band that will fit to the operating environment after the change. When the operating frequency band is fixed, at Step 303, the upper system control device 104 refers to the I/F parameter optimization table 107, and acquires power supply voltage setting information and I/F parameter setting information, and then the process proceeds to Step 304. At Step 304, the parameter values acquired from the I/F parameter optimization table 107 are set to the transmitting side I/F macro 101 and to the receiving side I/F macro 102. The power supply voltage setting information and the I/F parameter setting information that the upper system control device 104 acquired are set up as the power supply voltage and the I/F parameters of the transmitting side I/F macro 101 and the receiving side I/F macro 102 though the power supply controller 105 and the I/F parameter controller 106, which completes changeover of the operating frequency band. After the completion of the changeover, the process returns to Step 301. As mentioned above, in response to a change of the operating environment, the changeover of the power supply voltage and the I/F parameters of the transmitting side I/F macro 101 and the receiving side I/F macro 102 is performed dynamically.

### Second Embodiment

Although it is possible to create the I/F parameter optimization table 107 of the first embodiment by connecting an external device to the transmission system of the first embodiment, it is also possible to do it with a test device built in the transmission system. The second embodiment shows an embodiment in the case where the test device for performing a training mode is built in the transmission system.

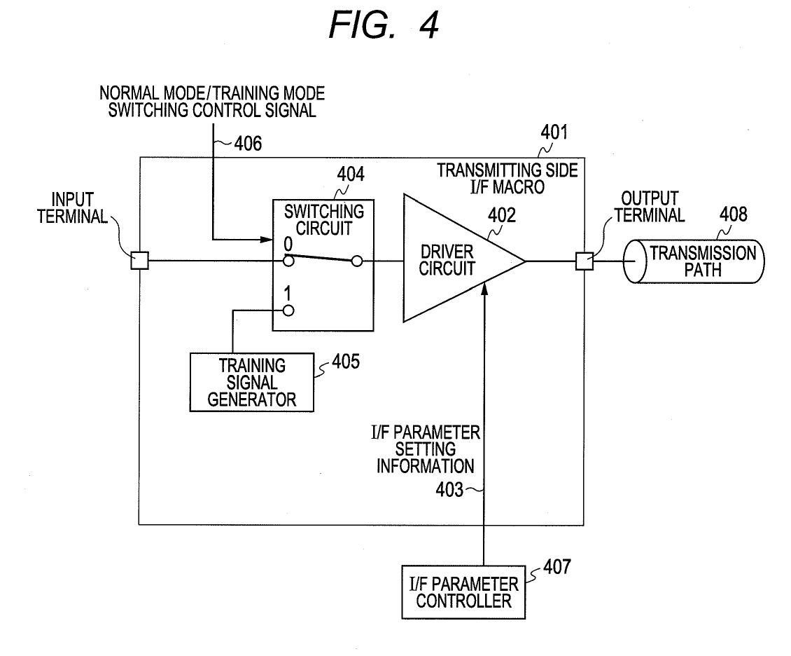

FIG. 4 shows a configuration of the transmitting side I/F in the case where the test device for performing a training mode is built in. A transmitting side I/F macro 401 outputs an LSI internal signal inputted into an input terminal toward a transmission line 408 that is connected from its output terminal to a later-described I/F for reception. The transmitting side I/F macro 401 is equipped with a driver circuit 402, a switching circuit 404, and a training signal generator 405.

The driver circuit 402 is an output circuit having the I/F parameter, and is made up of, for example, a CMOS type or CML type circuit. I/F parameter setting information 403 is signals transmitted from an I/F parameter controller 407. The I/F parameter setting information 403 is signals for controlling the I/F parameters of the driver circuit 402, for example, being control signals of an emphasis strength control, an output amplitude control, a sending-end resistance control, etc. The switching circuit 404 is a circuit for switching a normal mode and a training mode that will be described later, and is controlled by a normal mode/training mode switching control signal 406 transmitted from the upper system control device. The training signal generator 405 is a circuit for generating a signal used at the time of the training and, for example, is a signal generator for generating a pseudo random pattern, such as a PRBS (Pseudo Random Binary Sequence). Incidentally, although FIG. 4 shows a configuration example in which the transmitting side I/F macro 401 has the training signal generator 405 in its interior, it can also be installed outside the transmitting side I/F macro 401 or outside the system.

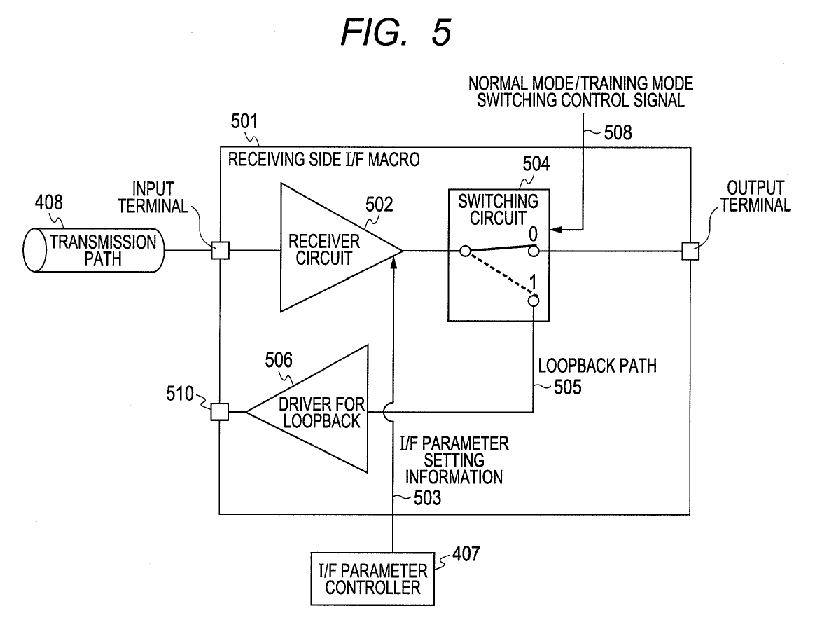

FIG. 5 shows details of the receiving side I/F macro. A normal operation of a receiving side I/F macro 501 is to transmit a signal received by the input terminal via the transmission line 408 connected to the transmitting side I/F macro 401 toward the interior of the LSI from its output terminal. The receiving side I/F macro 501 is equipped with a receiver circuit 502, a switching circuit 504, a loopback path 505, and a driver 506 for loopback. The receiver circuit 502 is an input circuit having the I/F parameter, and is made up of, for example, a CMOS type or CML type circuit. I/F parameter setting information 503 is signals for controlling the I/F parameters of the receiver circuit 502, which are, for example, control signals of an equalizer strength control, an offset adjustment control, a receiving-end resistance control, etc. The switching circuit 504 is a circuit for switching the normal mode and the training mode that will be described later, and is controlled by a normal mode/training mode switching control signal 508 from the upper system control device. The loopback path 505 and the driver 506 for loopback are observation routes used in the training mode, and output the signal that the receiver circuit 502 received to a loopback monitor terminal 510.

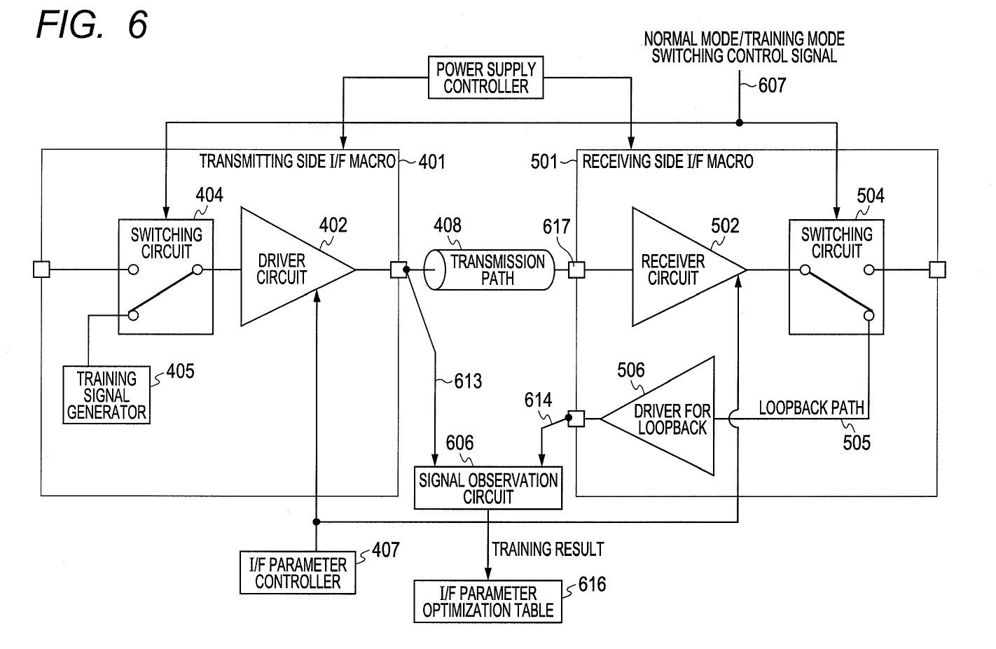

FIG. 6 is a diagram for explaining the training mode of the system including the I/F shown in FIG. 4 and FIG. 5. Objects of the training here are the transmitting side I/F macro 401 and the receiving side I/F macro 501 that are connected by the transmission line 408. At the time of the training, the each I/F macro is switched to the training mode.

Switching of each I/F micro to the training mode enables generation of the signal for training and loopback of outputting a received signal as a monitor signal. Switching to the training mode is done by a normal mode/training mode switching control signal 607 from the upper system control device. The transmitting side I/F macro 401 is of configuration when its mode is switched to the training mode, which transmits a signal outputted from the training signal generator 405 toward the receiving side I/F macro 501 through the switching circuit 404 via the transmission line 408 from the driver circuit 402. The receiving side I/F macro 501 is an example when the mode is switched to a loopback mode. The signal received by the receiver circuit 502 is outputted from the driver 506 for loopback through the switching circuit 504 via the loopback path 505. A signal observation circuit 606 is one that has a signal observation function, for example, being one that has a function of a BER measurement, an EYE mask pattern determination, or the like.

The signal observation circuit 606 compares an output signal 613 of the driver circuit 402 and an output signal 614 of the driver 506 for loopback, and makes a determination on transmission performance. In addition, it is also possible to observe the waveform outputted from the driver circuit 402 as it is after passing through the transmission line by observing the waveform of the input signal at the input terminal 617. The determination of the transmission performance by the signal observation circuit 606 is performed changing the combination of the I/F parameters if needed, and a training result, i.e., a determination result, is stored in an I/F parameter optimization table 616. Incidentally, about mounting of the signal observation circuit 606, it can be done either in the interior of the system or outside the system. If it is mounted outside the system, it is also possible to use measuring devices, such as a BERT and an oscilloscope. If it is mounted in the interior of the system, it is also possible to mount it on an LSI that is in common with the I/F macro.

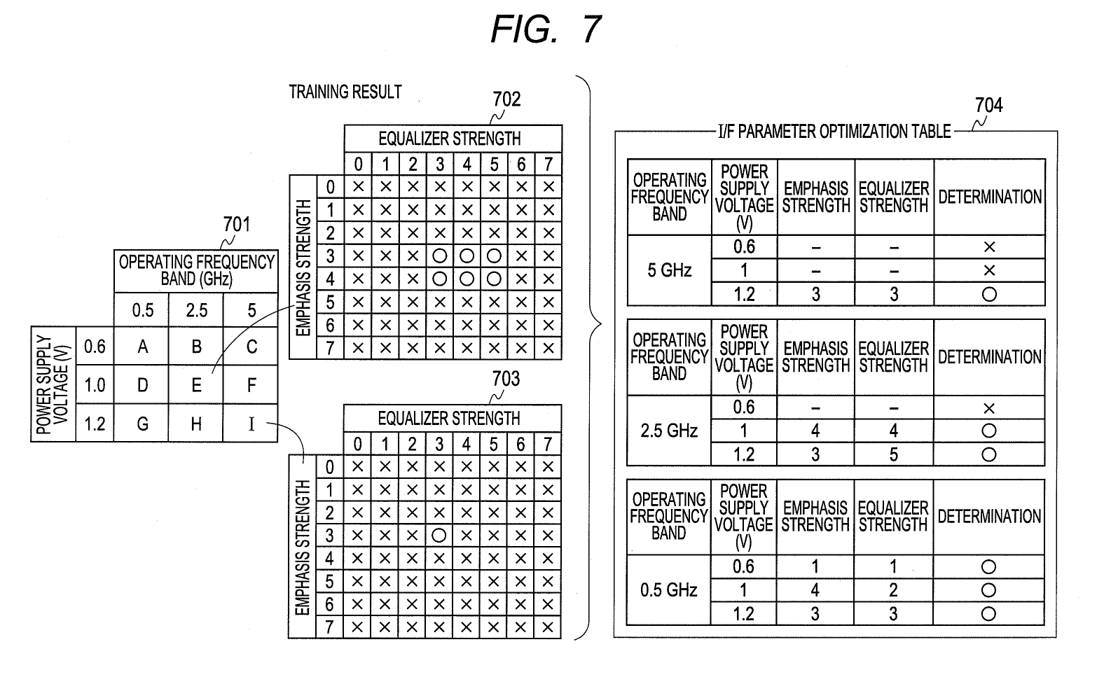

FIG. 7 shows the training to the I/F that has the emphasis strength (7:0) and the equalizer strength (7:0) as the parameters, and an example of data that is stored in the I/F parameter optimization table. In this example, the operating frequency band and the power supply voltage are selected as the parameters of the training. Operating environment parameters 701 are for a case where the power supply voltage is set to 0.6 V, 1.0 V, and 1.2 V, and the operating frequency band is set to 0.5 GHz, 2.5 GHz, and 5.0 GHz. A BER is acquired for conditions of A to I that are fixed by the operating environment parameters 701 by a method of applying every possible combination of the emphasis strength (7:0) and the equalizer strength (7:0). An example of the BER results acquired under the conditions of the operating environment parameters 701 is shown in training results 702, 703. I/F parameter optimization data is acquired from the BER results acquired to all the conditions of the operating environment parameters 701, and is stored in an I/F parameter optimization table 704. The I/F parameter optimization table is one that fixes the I/F parameter to a certain keyword, and is not limited to one that fixes the I/F parameters to the operating frequency band and the power supply voltage as shown in FIG. 7. It is possible to realize a table that fixes the I/F parameters to various keywords. It is possible to optimize the power supply voltage being fitted to the transmission line length: for example, at the time of formation of the I/F parameter optimization table, a training that uses the power supply voltage as a parameter is performed, and the power supply voltage can be lowered with a transmission line of a shorter distance even in the same operating frequency band, and so forth.

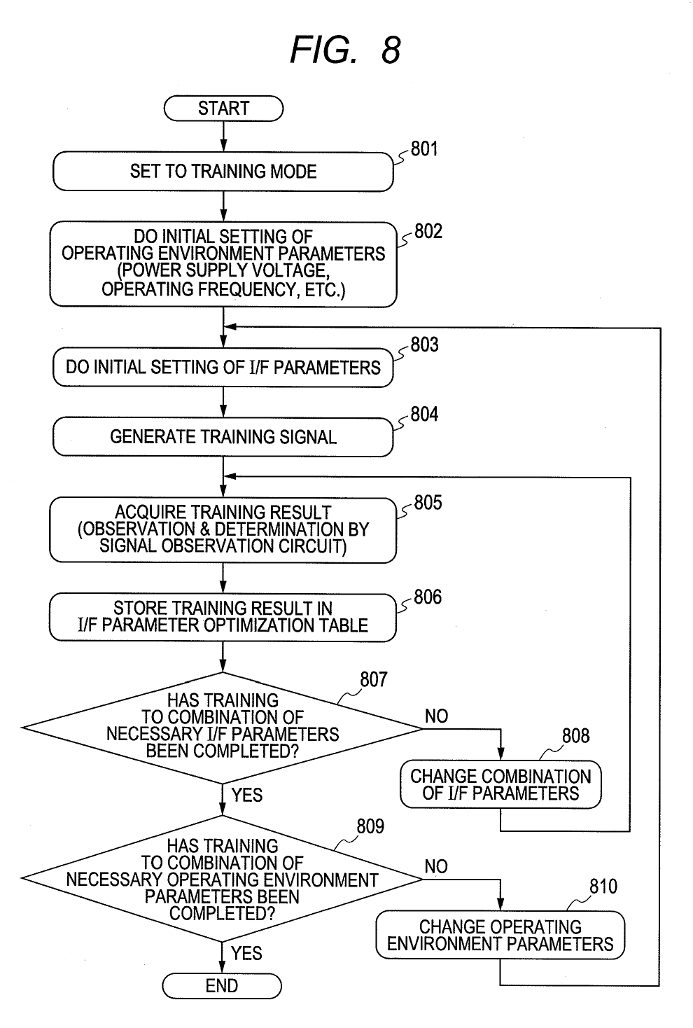

FIG. 8 shows a flowchart of the training in a training example shown in FIG. 7 with a configuration shown in FIG. 6. When performing the training, first the I/F is switched to the training mode at Step 801. A signal of the changeover to the training mode is sent from the upper system control device. At Step 802, initial values of the operating environment parameters are set up. The operating environment parameters are parameters that fix the power supply voltage, the operating frequency band, etc. A temperature, a transmission line length, etc. can be mentioned as other operating environment parameters. At Step 803, the I/F parameters are initialized. The initial values of the operating environment parameters and the I/F parameters determined at Step 802 and Step 803 are of an initial state of the training, and can be changed arbitrarily so as to fit to a specification of the training. At Step 804, a training signal is generated. At this time, the signal outputted from the training signal generator 405 of FIG. 6 is transmitted toward the receiving side I/F macro 501 through the switching circuit 404 via the transmission line 408 from the driver circuit 402. The receiving side I/F macro 501 outputs the signal received by the receiver circuit 502 from the driver 506 for loopback through the switching circuit 504 via the loopback path 505. The training result is acquired at Step 805. The signal observation circuit 606 observes the transmission performance and determines it. For example, it performs a BER evaluation by comparing the output signal 613 of the driver circuit 402 and the output signal 614 of the driver 506 for loopback, and makes the determination. At Step 806, the training result is stored in the I/F parameter optimization table. For example, at the time when the determination of an emphasis strength of 1 and an equalizer strength of 2 of the training result 702 is fixed, the training result is stored in the I/F parameter optimization table. At Step 807, it is determined whether the training to the combination of necessary I/F parameters is completed. The combination of necessary I/F parameters is one that is arbitrarily fixed according to the specification and a purpose of the training. In the example of FIG. 7, the combinations of necessary I/F parameters become combinations of 64 patterns with the emphasis strength (7:0) patterns and the equalizer strength (7:0) patterns. If the training to the combination of necessary I/F parameters is completed, the process will proceed to Step 809. If the training to the combination of necessary I/F parameters is not completed, the process will proceed to Step 808, where a combination of the I/F parameters will be newly set up, and the process will proceed to Step 805. It is determined whether the training to the combination of the operating environment parameters required at Step 809 is completed. The combination of necessary operating environment parameters is arbitrarily fixed according to the specification and the purpose of the training. In the example of FIG. 7, the combination of necessary operating environment parameters become a combination of total nine patterns with power supply voltages of 0.6 V, 1.0V, and 1.2 V and operating frequency bands of 0.5 GHz, 2.5 GHz, and 5.0 GHz to the each power supply voltage. If the combination of necessary operating environment parameters is not completed, the process will proceed to Step 810, where an operating environment parameter will be newly set up and the process will proceed to Step 803. If the combination of necessary operating environment parameters is completed, the training will be completed and the I/F parameter optimization table will be finished. The training is completed by the above steps 801 to 810. Thereby, a table of the optimum power supply voltage of the I/F and I/F parameters can be obtained in advance.

Although the present invention was explained in details by this embodiment in the foregoing description, the present invention is not limited to what was described above but can be altered within a range that does not depart from the gist of the present invention.

The transmission system of the present invention is a suitable one when being used for data transmission between LSIs, and the like.

What is claimed is:

1. A transmission system, comprising:
a first LSI;
a second LSI;
a transmitting side interface macro that is provided in the first LSI and has a plurality of operating frequency bands;
a receiving side interface macro that is provided in the second LSI and operates in the plurality of operating frequency bands;
a transmission line for connecting the transmitting side interface macro and the receiving side interface macro; and
a table of a power supply voltage and setting parameters of each of the plurality of operating frequency bands of the transmitting side interface macro and the receiving side interface macro,
wherein the power supply voltage and the setting parameters of the transmitting side interface macro and the receiving side interface macro are selected from the table according to the operating frequency to be used selected from among the plurality of operating frequency bands.

2. The transmission system according to claim 1,
wherein the setting parameters include an emphasis strength.

3. The transmission system according to claim 1,
wherein the setting parameters include an equalizer strength.

4. The transmission system according to claim 1, further comprising:
an upper system control device,
wherein the upper system control device selects the operating frequency band to be used selected from among the plurality of operating frequency bands according to an application that the first LSI and the second LSI process.

5. A transmission system comprising:
a transmitter having a plurality of operating frequency bands;
a receiver for operating in the plurality of operating frequency bands;
a transmission line for connecting the transmitter and the receiver; and
a table of a power supply voltage and setting parameters for each of the plurality of operating frequency bands of the transmitter and the receiver,
wherein the power supply voltage and the setting parameters are selected from the table according to the operating frequency band to be used selected from among the plurality of operating frequency bands.

6. The transmission system according to claim 5,
wherein the setting parameters include an emphasis strength.

7. The transmission system according to claim 6,
wherein the setting parameters include an equalizer strength.

8. A transmission method of data, comprising:
preparing a transmission system that has a transmitter having a plurality of operating frequency bands, a receiver for operating in the plurality of operating frequency bands, a transmission line for connecting the transmitter and the receiver, and a table of a power supply voltage and setting parameters for each of the plurality of operating frequency bands of the transmitter and the receiver;
selecting one of the plurality of operating frequency bands;
acquiring the power supply voltage and the setting parameters corresponding to the selected operating frequency band; and
setting the acquired power supply voltage and the setting parameters to the transceiver and the receiver.

9. The transmission method of data according to claim 8,
wherein the setting parameters include an emphasis strength.

10. The transmission method of data according to claim 8,
wherein the setting parameters include an equalizer strength.
